(19) United States
(12) Patent Application Publication
(10) Pub. No.: US 2025/0040761 A1
(43) Pub. Date: Feb. 6, 2025

(54) AUTOMATED METHOD AND SYSTEM FOR ADJUSTING THE SETTING OF ATTRIBUTES OF A PARTICLE PROCESSING SYSTEM

(71) Applicant: Terra Kaffe, Inc., Brooklyn, NY (US)

(72) Inventors: Sahand Dilmaghani, Brooklyn, NY (US); Vito DiMercurio, Seattle, WA (US); Hayden Riddiford, San Francisco, CA (US); Dave Scott Desrochers, Brooklyn, NY (US)

(21) Appl. No.: 18/362,939

(22) Filed: Jul. 31, 2023

Related U.S. Application Data
(60) Provisional application No. 63/348,000, filed on Jun. 1, 2022.

(51) Int. Cl. A47J 42/36; A47J 31/42

(52) U.S. Cl. CPC A47J 42/36; A47J 31/42

(57) ABSTRACT

Embodiments of improved systems including and methods for adjusting the setting of an attribute of a particle processing system where the particles may be directed to the particle processing system from a storage container. Other embodiments may be described and claimed.

### TECHNICAL FIELD

Various embodiments described herein relate generally to automated methods and systems for adjusting the setting of an attribute of a particle processing system.

### BACKGROUND INFORMATION

It may be desirable to provide automated systems and methods for adjusting the setting of an attribute of a particle processing system; the present invention provides such systems and methods.

### BRIEF DESCRIPTION OF THE DRAWINGS

FIG. 1A is a simplified diagram of an automated system that improves the processing of a desired quantity or dose of particles from a storage container according to various embodiments.

FIG. 1B is a simplified diagram of an automated system that improves the processing of a desired quantity or dose of particles from a storage container to a particle processing mechanism via a particle distribution mechanism according to various embodiments.

FIG. 1C is a simplified diagram of an automated system that improves the production of coffee via the processing of a desired dose of coffee beans from a storage container via a coffee bean grinder for use by a brew unit via a first chute according to various embodiments.

FIG. 1D is a simplified diagram of an automated system that improves the production of coffee via the processing of a desired dose of coffee beans from a storage container via a coffee bean grinder for use by a brew unit via a second chute according to various embodiments.

FIGS. 1E and 1F are simplified diagrams of automated systems that improves the production of coffee via the processing of a desired dose of coffee beans processed to a desired attribute from a storage container via a coffee bean grinder for use by a brew unit according to various embodiments.

FIG. 2A is a diagram of an algorithm for processing a desired quantity or dose of particles from a storage container according to various embodiments.

FIG. 2B is a diagram of an algorithm for processing a desired quantity or dose of particles from a storage container to a particle processing mechanism via a particle distribution mechanism according to various embodiments.

FIG. 2C is a diagram of an algorithm for production of coffee/espresso via the processing of a desired dose of coffee beans from a storage container via a coffee bean grinder for use by a brew unit according to various embodiments.

FIG. 2D is a diagram of an algorithm for alerting about the level of particles in a storage container according to various embodiments.

FIG. 2E is a diagram of an algorithm for adjusting the setting of an attribute of a particle processing system according to various embodiments.

FIG. 3A is a simplified isometric drawing of a particle processing module (PPM) with systems for setting an attribute of the PPM.

FIG. 3B is a simplified top drawing of a particle processing module (PPM) with systems for setting an attribute of the PPM.

FIG. 3C is a simplified side drawing of a particle processing module (PPM) with systems for setting an attribute of the PPM.

FIG. 4 is a block diagram of an article according to various embodiments.

### DETAILED DESCRIPTION

In an automatic system that includes a particle storage container coupled to a particular processing mechanism directly or via a particle distribution mechanism that distributes particles from the storage container, it is desirable to process a known quantity or amount of the particles. The quantities of particles 5 may be a volume or weight of the particles 5. In an embodiment, the desired processed quantity is based on the weight of processed particles from a storage container. In an embodiment, the desired particle 5 weight (termed dose) may vary as a function of the next use of the particles 5. In an embodiment, the storage container ideally may hold many doses of particles, about 5 to 200 doses in an embodiment.

In an embodiment, the particles may be coffee beans (roasted or green) and the storage container (termed a hopper in an embodiment) may hold the coffee beans. To create a brewed espresso weighting about 20-350 g (grams), 7 to 16 grams of coffee beans may be ideally consumed-used. For regular coffee, however a different quantity of coffee beans may be ideally consumed-used. Accordingly, in an automated system and method for processing particles (such as coffee beans) from a storage container (such as coffee bean hopper), the desired dose (weight) of particles in a dose (coffee beans) may vary as a function of the next usage of the particles (to produce an espresso, cup of coffee, for example).

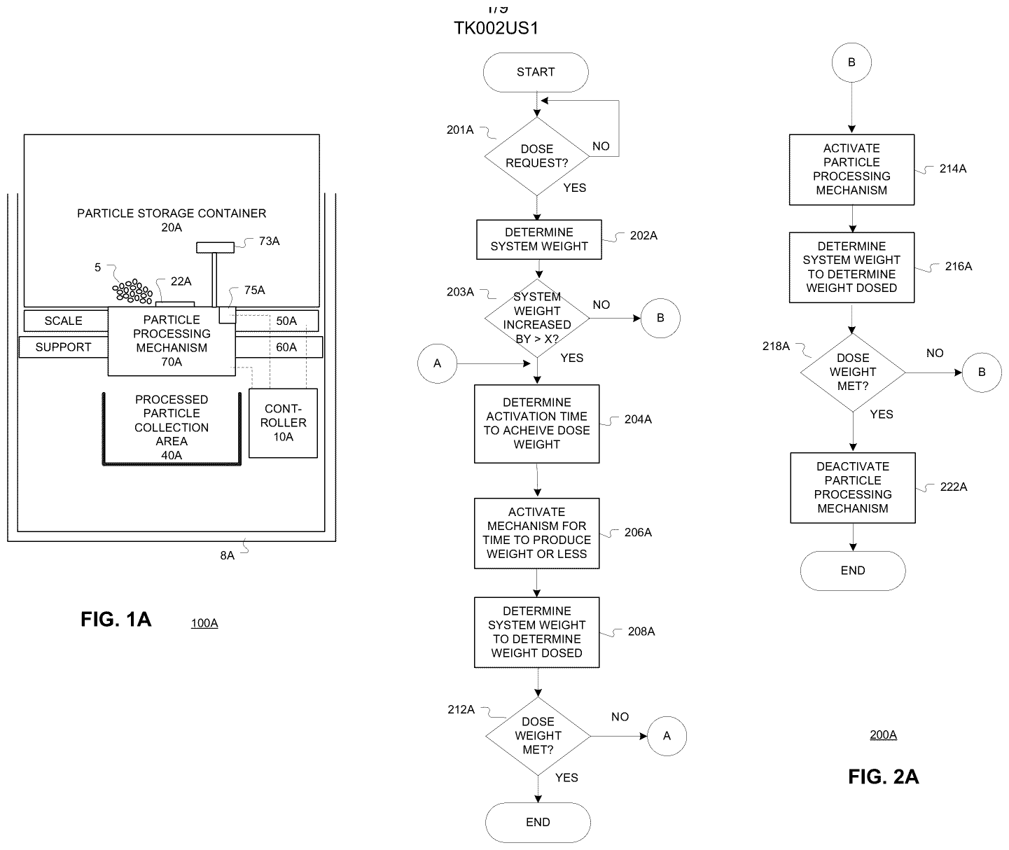

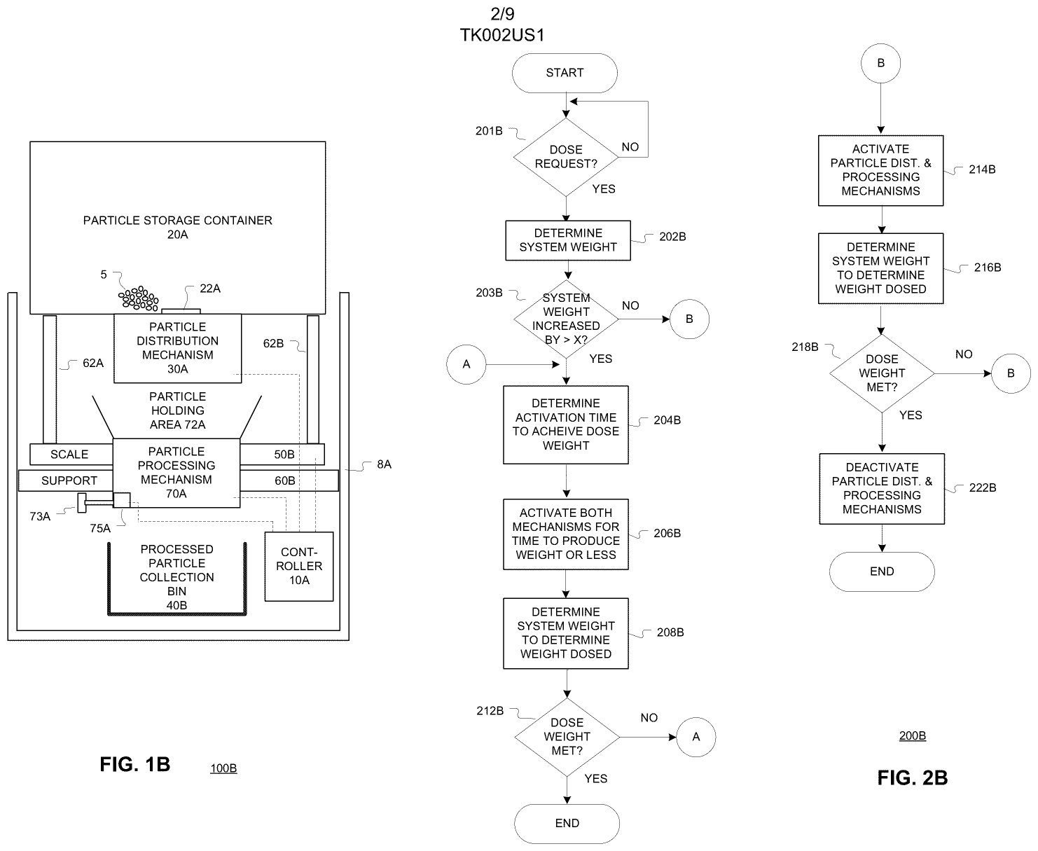

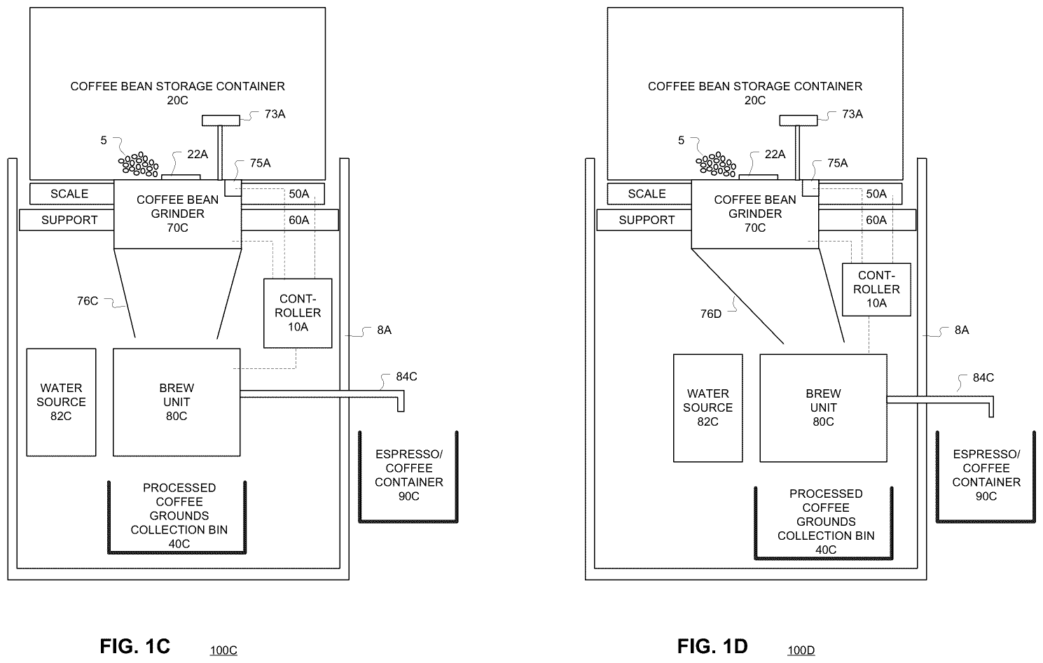

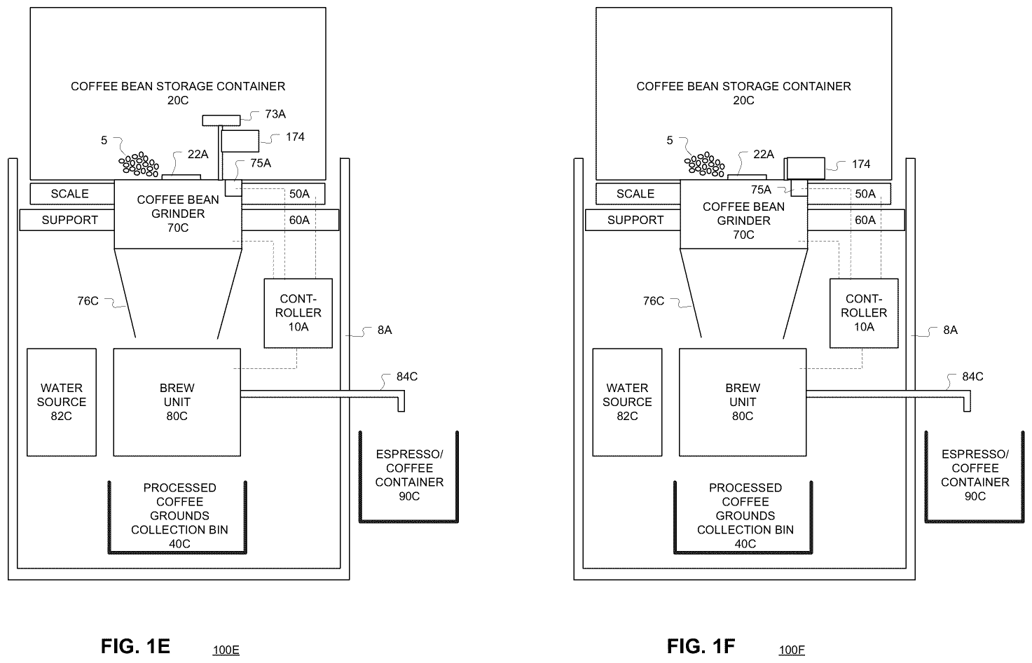

FIG. 1A is a simplified diagram of an automated system 100A that improves the processing of a desired quantity or dose of particles 5 from a storage 20A container according to various embodiments. As shown in FIG. 1A, the system 100A may include a particle storage container 20A, particle processing mechanism 70A, scale or weighting mechanism/module 50A, support 60A, a particle collection bin 40A, the wall 8A, and a controller 10A. In an embodiment, the particle storage container (PSC) 20A may communicate particles 5 via an opening 22A to the particle processing mechanism (PPM) 70A. In an embodiment, the PSC 20A and PPM 70A may be coupled to the scale or weight module 50A so the weight module 50A can determine the weight of the combination of the PSC 20A, PPM 70A, and any particles 5 therein. The weight module 50A may be coupled to the support 60A. The particle collection bin 40A may not be directly coupled the PSC 20A or PPM 70A. As shown in FIGS. 1A-C, the support 60A may be coupled to a wall 8A or main section of the system 100A-C while the PSC 20A/PPM 70A combination is effectively floating via the scale 50A from the wall or main section 8A.

A controller 10A may be coupled to the scale or weight module 50A and receive either an analog or digital signal that indicates the weight of the combination of the PSC 20A, PPM 70A, and any particles 5 therein. The controller 10A may also know/store the weight of the combination of the PSC 20A, PPM 70A alone (no particles)—i.e., the tare weight. Based on the tare weight, the controller 10A may be able to determine the current weight of any particles 5 in the combination of PSC 20A, PPM 70A based on the weight module signal 50A at any time.

In an embodiment, the combination of the PSC 20A and PPM 70A may have a tare weight of about 100 to 2000 grams and be able to store from 100 to 1000 grams of particles 5. The weight module 50A may be able to affect or provide a signal indicating weights from 10 to 3000 grams with an accuracy of 0.1 to 2.0 grams in an embodiment. In an embodiment, the weight module 50A may include a load cell, strain gauge, or other devices capable of providing the required degree of accuracy as a function of the particle 5 weight and dose weight.

The controller 10A may also be coupled to the PPM 70A to control and vary the processing rate of particles 5 such as 1 to 50 particles for a predetermined time interval (such as per second . . . ) if so desired in an embodiment. For example, in an embodiment, the PPM 70A may include a motor coupled to a processing device such as blades, burrs or other particle processing device to process particles for various uses including by another device.

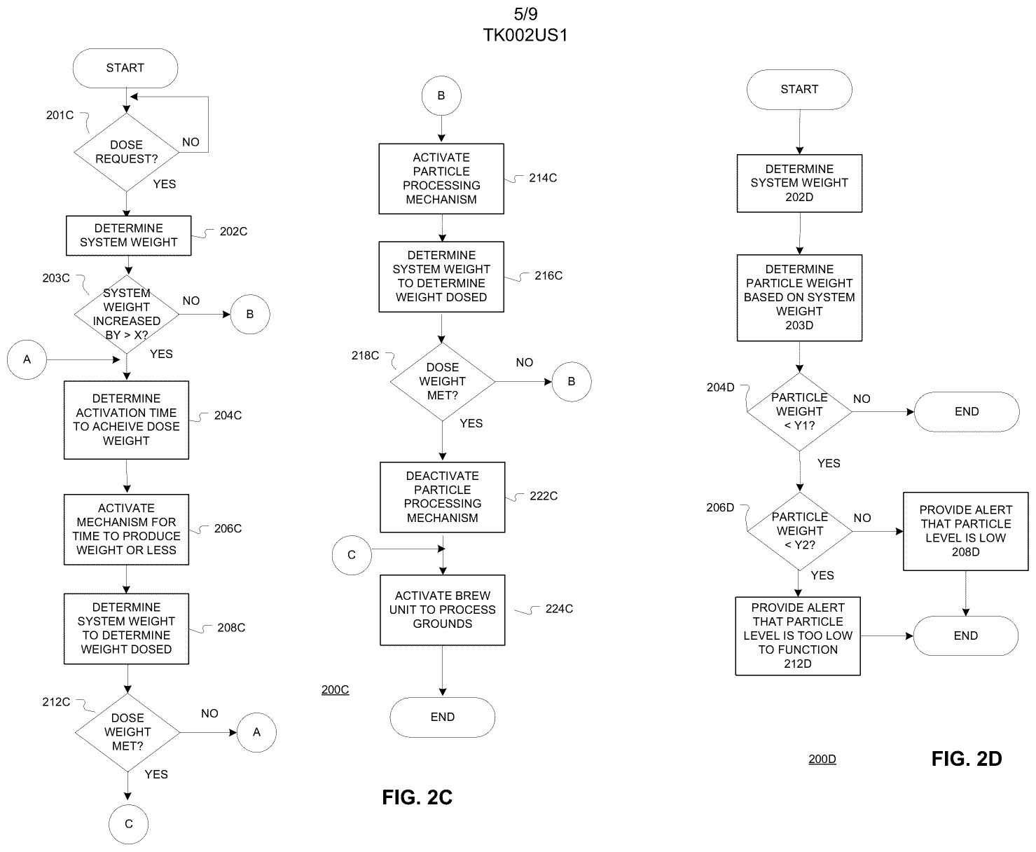

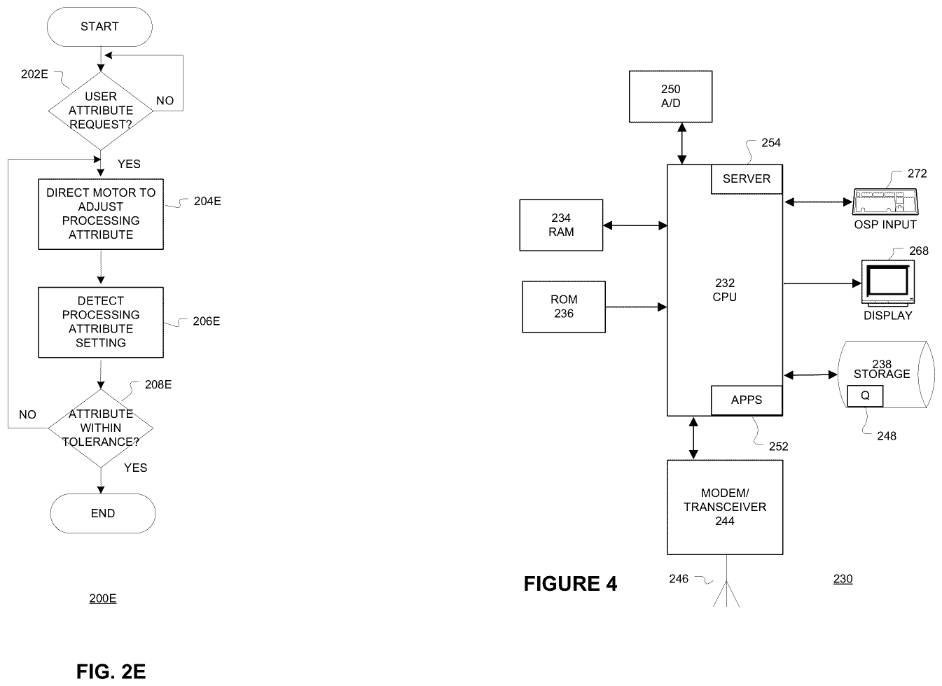

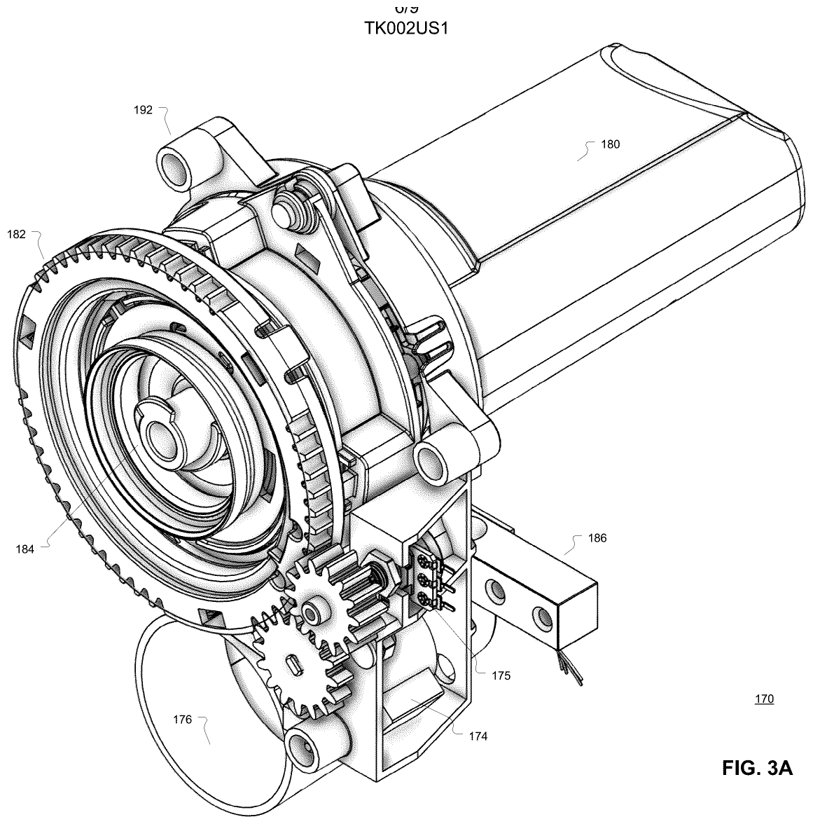

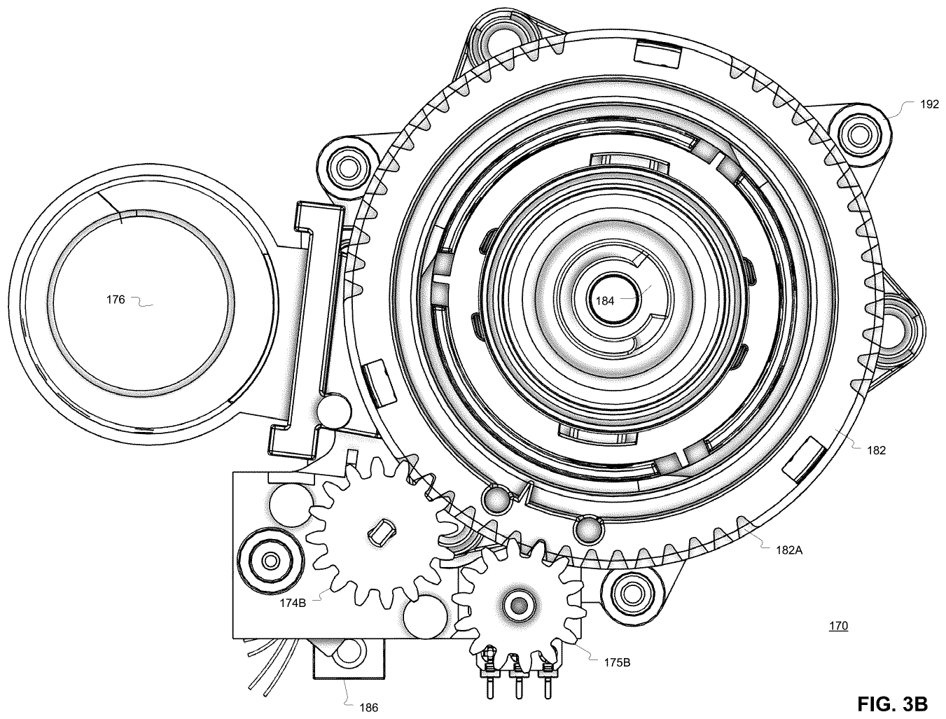

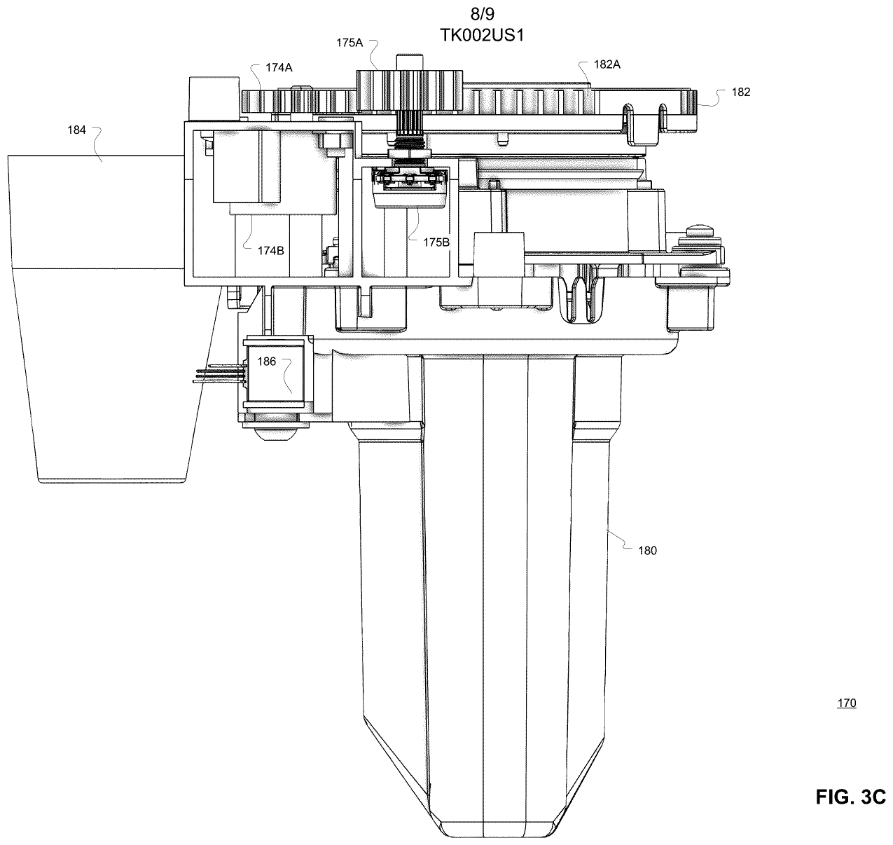

In operation, controller 10A may employ the algorithm 200A shown in FIG. 2A to direct the operation of the PPM 70A to process and produce a desired weight (dose) of particles 5 for various uses including into a particle collection bin 40A when a dose of certain weight of particles 5 is requested (activity 201A). In an embodiment, a User via an input device 272 (FIG. 3) or a User device communicating with the controller 10A via an interface 244 (FIG. 3) may request an operation that processes or requires the processing of a certain weight of particles 5 from the PSC/PPM combination such as 7 to 16 grams of processed particles (coffee beans) to produce a beverage of 20 to 350 grams.

In an embodiment, activities 214A-222A alone may be performed when a dose is requested (activity 201A) via the controller 10A. The controller 10A may activate the particle processing mechanism (PPM) 70A (activity 214A) to process particles 5 located in the PSC 20A. The controller 10A may also communicate with the scale 50A to determine the current system weight. Based on the differential between the system's (PSC/PPM) starting weight and current weight, the controller 10A may determine that a certain weight of particles 5 has been processed by the PPM 70A and passed into the collection area 40A (activity 216A). Once the desired dose weight is met (measured-activity 218A), the controller 10A may deactivate the PPM (activity 222A). In an embodiment, the controller 10A via the known tare weight of the PSC/PPM may also be able to determine the weight of particles 5 stored in the PSC 20A and report same to a User and prevent operation of the PPM 70A when the particle 5 weight is less than a requested dose.

In an embodiment, the controller 10A may employ algorithm 200D periodically or when a dose is requested to determine the weight of particles 5 currently in the system (activities 202D, 203D) based on the system's known tare weight (with no particles 5). When the determined particle 5 weight is less than a first predetermined level (Y1) but sufficient to generate a dose (Y2) (activities 204D, 206D), an alert that the particle 5 level in the system is low may be provided to a User via a display 268 of architecture 200A-C or message communicated to a User device via a modem/transceiver 244 (activity 208D). When the determined particle 5 weight is less than the weight needed to produce/generate a dose (Y2), an alert that the particle 5 level in the system is too low to produce a dose may be provided to a User via a display 268 of architecture 200A-C or message communicated to a User device via a modem/transceiver 244 (activity 212D). In an embodiment, Y1 may be a multiple of Y2, i.e., a predetermined number of dose weight (or average dose weight) including 2 to 10 doses in an embodiment.

In an embodiment, the controller 10A may store the current PSC/PPM (with particles 5) weight. In an embodiment, when the current system PSC/PPM (with particles 5) weight increases such as by a User adding particles 5 to the PSC 20A by a certain amount X (activity 203A) or where the PPM 70A operation affects the ability of the scale 50A to accurately determine the weight of the PSC/PPM (with particles 5), then the controller 10A may employ activities 204A-212A to process a desired dose of particles 5. In an embodiment, X may be two or more dose levels. In an embodiment, the controller 10A may also be able to receive an indication from the PPM 70A of its cycles performed.

In an embodiment based on the requested dose, the controller 10A may determine the activation time for the PPM 70A to achieve the requested dose weight (activity 204A). The activation time may be based on preprogrammed ratios of time to process particles by the PPM 70A to achieve the desired dose. Such ratios may be based on calibration of the PPM for certain particles 5 (such as different types of coffee beans). The User may be able to specify the particles 5 type in the PSC 20A so the activation time may be adjusted accordingly. In addition, the controller 10A via another device such as an optical sensor may be able to determine attributes of the particles 5 stored in the system (PSC 20A and PPM 70A).

In an embodiment, a User may also be able to set attributes of the PPM 70A that affect how the particles 5 are processed (such as via adjustment knob 73A) and the controller 10A may be able to detect the current attribute setting of the PPM 70A via a sensing module 75A. FIGS. 1E and 1F are simplified diagrams of an automated systems 100E and 100F that improve the production of coffee via the processing of a desired dose of coffee beans to a desired attribute from a storage container via a coffee bean grinder for use by a brew unit according to various embodiments. As shown in FIGS. 1E-1F, systems 100E-F may further include an adjusting system 174 for adjusting a setting of a particle processing attribute (grind level in an embodiment) of a PPM (including a coffee bean grinder 70C in an embodiment). As shown in FIG. 1E, the adjusting system 174 may be coupled to an adjustment knob 73A so a User may manually adjust the attribute or employ the system 174 via the controller 10A to adjust the attribute.

In an in embodiment, the controller 10A may employ the algorithm 200E shown in FIG. 2E to adjust the desired particle processing attribute when directed to do so by a User (activity 202E). The controller 10A may direct a motor 174B (as shown in FIGS. 3A-3C) of the adjusting system 174 to adjust a processing attribute (activity 204E). Then the controller 10A via a sensing system 75, 175 (FIGS. 3A-3C) may detect the current processing attribute setting (activity 206E). The controller 10A may continue to direct the motor 174B of the adjusting system 174 to adjust the processing attribute until the attribute is within a predetermined tolerance (activity 208E). In an embodiment, the processing attribute may have a fixed number or integer levels. In another embodiment, the processing attribute may be more variable and have less finite number of settings.

For example, a PPM 70A may be a grinder, the adjustment knob 73A or systems 74, 174 may set its particle grind size setting (particle processing attribute) to one of several fixed levels (from coarse, less coarse, normal, fine, very fine for example) or variable levels from coarse to fine. The sensing module/system 75A, 175 may be able to communicate the grinder size setting to the controller 10A and the desired processing attribute set via the algorithm 200E. Based on the grind size setting, the activation time may be increased (for finer grind) or reduced (for coarser grind) in an embodiment. In an embodiment, the sensing module/system 75A, 175 may include a potentiometer 175A that is coupled to the control knob 73A to provide a signal to the controller 10A indicating the control knob 73A state.

In an embodiment, shown in FIGS. 3A-3C, the sensing system 175 may include a gear 175B coupled to a potentiometer 175A where the potentiometer 175A senses the rotation to the gear 175B to determine the particle processing attribute (grind setting in an embodiment). For example, the PPM 70A may be a grinder, the adjustment knob 73A may set its particle grind size setting (from coarse to fine for example), and the sensing module 75A, 175 may be able to communicate the grinder size setting to the controller 10A. FIG. 3A is a simplified isometric drawing, FIG. 3B is a simplified top drawing, and FIG. 3C is a simplified side drawing of a particle processing module (PPM) 170 with systems 174, 175 for setting an attribute of the PPM according to various embodiments.

As shown in FIGS. 3A-3C, the PPM 170 may include a particle grinder with a system for adjusting a particle processing attribute 174 (adjusting system 174) and a system for sensing a particle processing attribute setting 175 (sensing system 175). In an embodiment, the PPM 170 includes a processing motor 180, intermediary gear 182 with teeth 182, particle entrance 184, processed particle chute 176, load cell 186, and supports 192 for particle storage. In an embodiment, the particle processing attribute of a PPM 170 may be adjustable via the position of the intermediary gear 182 via its teeth 182A.

In embodiment, the PPM 170 by a coffee grinder, the motor 180 a grinder motor, and the intermediary gear 182 may be rotated to set different coffee bean grind levels (setting grinding size of coffee beans). As shown in FIGS. 3A-3C, the adjusting system 174 may include a motor 174A rotatably coupled to a gear 174B. The gear 174B may have teeth sized to engage and interface with the intermediary gear 182 teeth 182 and positioned so they are fixably engaged thereto. In an embodiment the activation of the motor 174A may cause the motor 174A to rotate the gear 174B and thus the intermediary gear 182 in predetermined steps or increments (the motor 174A may be step motor in an embodiment.)

As also shown in FIGS. 3A-3C, the sensing system 175 may include a potentiometer 175A rotatably coupled to a gear 175B. The gear 175B, similar to gear 174B may also have teeth sized to engage and interface with the intermediary gear 182 teeth 182 and positioned so they are fixably engaged thereto. As the intermediary gear 182 is moved via the adjusting system 174 (or manually via 73A), the potentiometer 175A may detect the corresponding rotation of gear 175B and provide a signal that indicates the radial movement of the gear 175B. The signal providing the radial movement of the gear 175B may be interpreted to determine the setting of the particle processing attribute in an embodiment.

In an embodiment, the activation time for the PPM 70A may be selected to provide slightly less than the desired weight or dose to prevent over distribution of particles 5 (activity 204A). For example, where 14 grams of particles are desired (dose weight of 14 grams), the PDM 30A may be activated to process a certain percentage less (from 5 to 20% less) (activity 206A) and then weight the system-PSC/PPM-particles 5 remaining combination to determine the weight differential and thus dose weight (activity 208A) thus far. In particular, based on the combined weight of the PSC/PPM-particles 5 prior to PPM 70A activation (206A), and current weight, the dose of particles 5 distributed may be determined. When the dose weight is within a tolerance (within the weight mechanism accuracy) or a percentage of the dose weight in an embodiment (0.5 to 5% in an embodiment), the distribution process may be complete (activity 212A).

For example, where the desired dose weight is 14 g, the desired accuracy may be 0.2 g or about one particle (coffee bean). Otherwise, the differential between the required weight or dose and that has been processed thus far may be determined and used to determine a differential dose to be processed using algorithm activities 204A-212A until the desired total dose is processed within tolerance. Such a process (versus activities 214A-222A) may eliminate weighting errors versus continuously weighting the combination of PSC/PPM-remaining particles 5 while the PPM 70A is actively processing particles 5. Such a process (activities 204A-212A) may also enable particles 5 and processed particles to move about the system PSC/PPM. For example, ground coffee may adhere to the PPM 70A or chutes (76C, 76D, FIGS. 1C-1D).

FIG. 1B is a simplified diagram of another automated system 100B that improves the processing of a desired quantity or dose of particles 5 from a storage container 22A to a collection bin 40B via a particle distribution mechanism 30A (PDM) and a particle processing mechanism 70A according to various embodiments. As shown in FIG. 1B, the system 100B further includes a particle distribution mechanism 30A (PDM), and a particle holding area 72A. As shown in FIG. 1B, the PSC 20A and PDM 30A may be coupled to the scale 50B via supports 62B. Similar to system 100A, the PPM 70A may also be coupled to the scale 50B where the scale 50B coupled to a support 60B. In an embodiment the PDM 30A may be include various types of particle movement mechanisms including a rotating window, auger, or other mechanisms. The PDM 30A may be activated by the controller 10A and may cause particles 5 in the PSC 20A to transit to the particle holding area 72A. In an embodiment, the particle holding area 72A may be part of the PPM 70A.

In an embodiment, the controller 10A communicates with the PDM 30A, weight module 50A, sensing module 75A, and the PPM 70A. Controller 10A may employ the algorithm 200B shown in FIG. 2B to process particle dosing requests in system 100B. Algorithm 200B is similar to algorithm 200A other than the additional activation of the PDM 30A to move particles 5 to the PPM 70A for processing. In an embodiment, the controller 10A may activate the PDM 30A at the same time as the PPM 70A and keep both operating until the desired dose weight is achieved (activity 212B, 218B). In another embodiment, the controller 10A may activate the PDM 30A first, for a time interval, loading the holding area 72A or at least partially loading the holding area 72A prior to activating the PPM 70A as function of particle consumption speed of the PPM 70A versus the particle distribution speed of the PDM 30A. The weight of the system 100B may include the PSC 20A, PDM 30A, holding area 72A, PPM 70A and any particles 5 in the PSC 20A and holding area 72A.

FIG. 1C is a simplified diagram of an automated system 100C that improves the production of espresso-coffee via the initial processing of a desired dose of coffee beans 5 from a storage container 20C via a coffee bean grinder 70C for use by a brew unit 80C according to various embodiments. As shown in FIG. 1C, the system 100C includes a PSC 20C, scale-weight mechanism 50A, support 60A, controller 10A, coffee bean grinder 70C, processed particle chute 76C, brew unit 80C, water source 82, processed coffee grounds collection bin 40C, brew unit spout 84C, and espresso-coffee container 90C. In the embodiments 100A and 100C, the PSC 20A may have an opening 22A that enables particles 5 to pass to the PPM 70A for processing when activated by a controller 10A. In an embodiment, the controller 10A may employ the algorithm 200C shown in FIG. 2C to generate coffee or expresso for collection by the coffee container 90C at the direction of a User via a system input device 272 or User device communicating the controller 10A via a modem-transceiver 244 (FIG. 3).

Algorithm 200C shown in FIG. 2C is similar to the algorithm 200B other than the additional activity of the controller 10A activating the brew unit 80C (activity 224C), after the PPM 70A has processed the desire dose of coffee beans (produced the desired weight of coffee grounds). As shown in FIG. 1C, a processed particle chute 76C may direct the processed particles (coffee grounds) to a brew unit 80C. FIG. 1D shows another processed particle chute 76D. In an embodiment, the chutes 76C, 76D ideally enable grounds to move via gravity to the brew unit for processing. Processed particles that remain in a chute 76C, 76D due to geometry or clumping, may remain part of the measured system weight until they exit the chute 76C, 76D completely in an embodiment. In an embodiment, the chute 76C, 76D walls have at least a 45-degree angle relative to the next processing unit.

FIG. 3 illustrates a block diagram of a device 230 that may be employed as a controller 10A in various embodiments to perform the algorithms 200A-C and communicate with a User device. The device 230 may include a CPU 232, a RAM 234, a ROM 236, a storage unit 238, a modem/transceiver 244, a digital to analog converter 250, an input module 272, display module 268, and an antenna 246. The CPU 232 may include a web-server 254 and application module 252. The RAM 234 may include a queue or database where the database may be used to store information including particle data, requests for distributions, and user information such as desired doses for various particle usage. The storage 238 may also include a queue or database 248 where the database 248 may be used to store particle distribution requests and related processing requests in an embodiment. In an embodiment, the server 254 and the application module 252 may be separate elements. In an embodiment, the server 254 may generate content for web-pages or displays to be forwarded to a user to control the operation of a system 100A-D.

The user input device 272 may comprise an input device such as a keypad, touch screen, track ball or other similar input device that allows the user to navigate through menus, displays in order to operate systems 100A-D. The display 268 may be an output device such as a CRT, LCD, touch screen, or other similar screen display that enables the user to read, view, or hear received messages, displays, or pages from the system 100A-D.

The modem/transceiver 244 may couple, in a well-known manner, the device 230 to a user device to enable communication with the CPU 232. In an embodiment, the modem/transceiver 244 may be a wireless modem or other communication device that may enable communication with a user device. The CPU 232 via the server 254 or application 252 resident on a user device may direct communication between modem 244 and a User device such as a User's cellphone, smart watch, tablet, computer, or other electronic device having wireless communication capability.

The ROM 236 may store program instructions to be executed by the CPU 232, server 254, or application module 252. The RAM 234 may be used to store temporary program information, queues, databases, and overhead information. The storage device 238 may comprise any convenient form of data storage and may be used to store temporary program information, queues, databases, and overhead information.

Such embodiments of the inventive subject matter may be referred to herein individually or collectively by the term “invention” merely for convenience and without intending to voluntarily limit the scope of this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. § 1.72 (b), requiring an abstract that will allow the reader to quickly ascertain the nature of the technical disclosure. It is submitted with the understanding that it will not be used to interpret or limit the scope or meaning of the claims. In the foregoing Detailed Description, various features are grouped together in a single embodiment for the purpose of streamlining the disclosure. This method of disclosure is not to be interpreted to require more features than are expressly recited in each claim. Rather, inventive subject matter may be found in less than all features of a single disclosed embodiment. Thus, the following claims are hereby incorporated into the Detailed Description, with each claim standing on its own as a separate embodiment.

What is claimed is:

1. A system for setting a mechanically adjustable attribute (MAA) of a particle processing system (PPS) that changes the mechanical processing of particles, including:
an adjusting motor mechanically coupled to the PPS so that when the motor is activated, the MAA is adjusted;
a sensor mechanically coupled to the PPS so that when the MAA is adjusted the sensor can detect the adjustment; and
a controller electrically coupled the adjusting motor and the sensor to controllably adjust the MAA via the adjusting motor and the sensor to a desired setting.

2. The system for setting a MAA of a PPS of claim 1, wherein the controller adjusts the MAA via the adjusting motor and the sensor to a desired setting within a predetermined tolerance.

3. The system for setting a MAA of a PPS of claim 1, wherein the sensor includes a potentiometer.

4. The system for setting a MAA of a PPS of claim 1, wherein the controller adjusts the MAA via the adjusting motor and the sensor to one of a fixed number of levels.

5. The system for setting a MAA of a PPS of claim 1, wherein PPS is a grinder, the MAA is grinding size of particles to be processed.

6. The system for setting a MAA of a PPS of claim 5, wherein the particles to be processed are coffee beans.

7. The system for setting a MAA of a PPS of claim 5, wherein the controller can determine the particle grinding size via the sensor.

8. The system for setting a MAA of a PPS of claim 5, wherein the PPS includes a grinder motor and the intermediary gear that may be rotated to set different grind levels.

9. The system for setting a MAA of a PPS of claim 8, wherein the adjusting motor is mechanically coupled to the intermediary gear.

10. The system for setting a MAA of a PPS of claim 9, wherein the sensor is mechanically coupled to the intermediary gear.

11. The system for setting a MAA of a PPS of claim 8, wherein the intermediary gear includes teeth and the adjusting motor includes a gear with teeth sized to mechanically engage the teeth of the intermediary gear.

12. The system for setting a MAA of a PPS of claim 11, wherein the sensor includes a gear with teeth sized to mechanically engage the teeth of the intermediary gear.

13. The system for setting a MAA of a PPS of claim 11, wherein the PPS includes one of blades and burrs and rotating the intermediary gear modifies the operation of one of the blades and the burrs.

14. A method of setting a mechanically adjustable attribute (MAA) of a particle processing system (PPS) that changes the mechanical processing of particles, including:
adjusting a motor mechanically coupled to the PPS to adjust the MAA;
detecting the MAA setting via a sensor mechanically coupled to the PPS; and
employing a controller electrically coupled the motor and the sensor to controllably adjust the MAA setting via the adjusting motor and the sensor to a desired setting.

15. The method of setting a MAA of a PPS of claim 14, including employing the controller to adjust the MAA setting via the adjusting motor and the sensor to a desired setting within a predetermined tolerance.

16. The method of setting a MAA of a PPS of claim 15 wherein the sensor includes a potentiometer.

17. The method of setting a MAA of a PPS of claim 15, employing the controller to adjust the MAA setting via the adjusting motor and the sensor to one of a fixed number of levels.

18. The method of setting a MAA of a PPS of claim 14, wherein PPS is a grinder, the MAA setting is the grinding size of particles to be processed.

19. The method of setting a MAA of a PPS of claim 18, wherein the particles to be processed are coffee beans.

20. The method of setting a MAA of a PPS of claim 18, wherein the particles to be processed are coffee beans.
